(19) United States
(12) Patent Application Publication
(10) Pub. No.: US 2008/0250403 A1
(43) Pub. Date: Oct. 9, 2008

(54) METHOD AND APPARATUS FOR GENERATING FIRMWARE UPDATE FILE AND UPDATING FIRMWARE BY USING THE FIRMWARE UPDATE FILE

(75) Inventors: Ji-young Moon, Seoul (KR); Il-jun Lee, Yongin-si (KR); Jun-bum Shin, Suwon-si (KR); Sun-nam Lee, Suwon-si (KR); Sang-hong Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/877,184

(22) Filed: Oct. 23, 2007

(30) Foreign Application Priority Data
Apr. 6, 2007 (KR) 10-2007-0034421

(51) Int. Cl. G06F 9/44

(52) U.S. Cl. 717/169

(57) ABSTRACT

Provided is a method of limiting updating of firmware by distinguishing between model code that represents a group of hardware having firmware program codes are compatible with each other and model code that identifies each hardware belonging to the group. The method includes generating a data body having firmware program code that is to be updated; generating a data header having model code of hardware to which the data body is to be applied, wherein the hardware model code comprises first model code representing a group of hardware having firmware program codes are compatible with each other and second model code identifying each hardware belonging to the group; and generating a firmware update file by combining the data body and the data header.

### CROSS-REFERENCE TO RELATED PATENT APPLICATIONS

This application claims priority from Korean Patent Application No. 10-2007-0034421, filed on Apr. 6, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to generating a firmware update file and updating firmware by using the firmware update file, and more particularly, to updating firmware by categorizing hardware model codes to which firmware is applied into hardware model code representing a group of hardware whose firmware program codes are compatible with each other and hardware model code identifying the hardware belonging to the group.

2. Description of the Related Art

Firmware that controls and manages hardware is a special program being different not only from hardware since it is a program but also from general application programs since it is closely related to hardware. That is, firmware retains both software and hardware characteristics. In general, firmware is stored in read-only memory (ROM), that is, flash memory.

For example, if all circuits for controlling hardware having a function are manufactured in only a hardware manner, the structures of the circuits may be very complicated and there may be logical expressions that are difficult to be manifested simply using circuits. This problem can be solved in a very simple and low-cost manner that a large part of the circuits are replaced with software and a memory device storing the software is made as the center of the hardware. Such software having hardware characteristics is referred to as firmware.

In general, a system with various functions, and in particular, an embedded system includes firmware therein so as to execute the functions. Firmware is generally used in order to store a small-scale single program rather than a large-scale program such as an operating system. Thus, since the firmware is a small-scale program, it must be frequently updated in order to improve an error in the firmware, the system performance, or add a new function thereto.

However, firmware designed for a particular hardware model may be used for another hardware model during firmware updating. For example, firmware with the logo of a company “B” is available to a set up box printed with the logo of a company “A”.

Also, in case where the region code of updated firmware is not identical to that of hardware, legal troubles may occur in a foreign country. If updating is made with inappropriate firmware, additional costs may be incurred accordingly.

### SUMMARY OF THE INVENTION

The present invention provides a method of generating a firmware update file that limits updating of firmware included in hardware by distinguishing between model code that represents a group of hardware whose firmware program codes are compatible with each other, and model code that identifies the hardware belonging to the group, and a method and apparatus for updating using the update file.

According to an aspect of the present invention, there is provided a method of generating an update file of firmware, the method including generating a data body having firmware program code that is to be updated; generating a data header having model code of hardware to which the data body is to be applied, where the hardware model code comprises first model code representing a group of hardware whose firmware program codes are compatible with each other and second model code identifying each hardware belonging to the group; and generating a firmware update file by combining the data body and the data header.

The generating of the data header may include generating the data header to further include a model flag field indicating whether the first and second model codes are valid. Also, the generating of the data header may include generating the data header to further include update mode information indicating whether updating of the firmware is compulsorily performed irrespective of a value of the model flag field.

If updating of the firmware is compulsorily performed, the generating of the data header may comprise setting the first model code included in the data header to a null value.

The generating of the data body may comprise generating the data body to further include the first and second model codes.

The generating of the data header may comprise generating the data header to further include region code of the hardware to which the data body is to be applied. The region code of the hardware may comprise at least one of free code, continent code, and country code.

The generating of the data header may comprise generating the data header to further include version information of the firmware program code included in the data body.

The generating of the firmware update file may comprise digitally signing the data body and the data header so as to prevent them from being forged or altered. The generating of the firmware update file may comprise encrypting the data body having the firmware program code.

According to another aspect of the present invention, there is provided a method of updating firmware using a firmware update file, the method including interpreting a data header included in an update file; reading as first model code one of model code representing a group of hardware to which the update file is to be applied and model code identifying each hardware belonging to the group, from the data header; comparing the first model code with second model code included in the hardware, where the second model code represents models of the hardware; and updating firmware in the hardware based on the comparison result.

The reading of the first model code may comprise interpreting a model flag field indicating whether the model code representing the hardware group and the model code identifying each hardware belonging to the group are valid; and determining one of these model codes as the first model code, based on a value of the model flag field.

If the model code representing the hardware group is read as the first model code according to the value of the model flag field, the updating of the firmware in the hardware may comprise updating the firmware in the hardware only if the second model code is included in the first model code.

If the model code identifying each hardware belonging to the group are valid is read as the first model code according to the value of the model flag field, the updating of the firmware in the hardware may include updating the firmware in the hardware only if the second model code is identical to the first model code.

The method may further include reading region code of the hardware to which the update file is to be applied, from the interpreted data header; and comparing the read region code with region code of the hardware that is included in the hardware so as to determine whether the firmware is to be updated. The method may further include comparing firmware version information preset in the hardware with version information included in the interpreted data header so as to determine whether the firmware is to be updated.

The method may further include interpreting update mode information indicating whether the firmware is compulsorily updated, where the update mode information is included in the data header; and if the result of interpreting the update mode information indicates a compulsory update mode, updating the firmware in the hardware, irrespective of the result of comparing the first and second model codes.

If the model code that is included in the data header and represents the group of the hardware to which the update file is to be applied, has a null value, the interpreting of the update mode information may comprise interpreting the update mode information to indicate the compulsory update mode.

The method may further include parsing the update file by dividing it into the data header that includes the model code representing a group of hardware to which the update file is to be applied and the model code identifying each hardware belonging to the group, a data body having firmware program code that is to be updated, and a digital signature that prevents the update file from being forged or altered.

The method may further include authenticating the parsed digital signature, wherein, if the authentication succeeds, the firmware in the hardware is updated.

If the parsed data body is encrypted, the method may further include decrypting the data body; interpreting model code representing a group of hardware to which the update file is to be applied and model code identifying each hardware belonging to the group, where the model codes are included in the decrypted data body; and comparing the interpreted model codes with the model codes included in the parsed data header in order to verify the integrity of the model codes included in the parsed data header.

According to another aspect of the present invention, there is provided a computer readable medium having recorded thereon an update file, the update file comprising a data body having firmware program code that is to be updated; and a data header having model code of hardware to which the data body is to be applied, where the model code comprises first model code that represents a group of hardware whose firmware program codes are compatible with each other and second model code that identifies each hardware belonging to the group.

According to another aspect of the present invention, there is provided a computer readable medium having recorded thereon a program for executing a method of generating an update file, the method comprising generating a data body having firmware program code that is to be updated; generating a data header having model code of hardware to which the data body is to be applied, where the hardware model code comprises first model code representing a group of hardware whose firmware program codes are compatible with each other and second model code identifying each hardware belonging to the group; and generating a firmware update file by combining the data body and the data header.

According to another aspect of the present invention, there is provided a computer readable medium having recorded thereon a program for executing a method of updating firmware using a firmware update file, the method comprising interpreting a data header included in an update file; reading as first model code one of model code representing a group of hardware to which the update file is to be applied and model code identifying each hardware belonging to the group, from the data header; comparing the first model code with second model code included in the hardware, where the second model code represents models of the hardware; and updating firmware in the hardware based on the comparison result.

According to another aspect of the present invention, there is provided an apparatus for generating a firmware update file, the apparatus comprising a firmware generator generating a data body having firmware program code that is to be updated; a header generator generating a data header having model code of hardware to which the data body is to be applied, where the model code comprises first model code representing a group of hardware whose firmware program codes are compatible with each other and second model code that identifies each hardware belonging to the group; and a combination unit generating a firmware update file by combining the data header and the data body.

The combination unit may comprise a digital signature unit digitally signing the data body and the data header so as to prevent them from being forged or altered; and an encryption unit encrypting the data body having the firmware program code.

According to another aspect of the present invention, there is provided an apparatus for updating using a firmware update file, the apparatus comprising a header interpreter interpreting a data header included in an update file; a model determination unit reading as first model code model code that represents a group of hardware to which the update file is to be applied or model code that identifies each hardware belonging to the group, from the interpreted data header; a model comparison unit comparing the first model code with second model code that is included in the hardware and indicates models of the hardware; and an update unit updating firmware in the hardware, based on the comparison result received from the model comparison unit.

The apparatus may further include a syntax parser parsing the update file by dividing it into the data header having the model code that represents a group of hardware to which the update file is to be applied and the model code that identifies each hardware belonging to the group, a data body having firmware program code that is to be updated, and a digital signature that prevents the update file from being forged or altered; a digital signature authentication unit authenticating the digital signature parsed by the syntax parser; a decryption unit decrypting the parsed data body if the digital signature authentication unit completes the authentication successfully and if the parsed data body is encrypted; and an update mode determination unit interpreting update mode information included in the data header interpreted by the header interpreter, where the update mode information indicates whether updating of the firmware is to be performed compulsorily.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart illustrating a method of generating a firmware update file, according to an exemplary embodiment of the present invention;

FIG. 2 is a flowchart illustrating a method of generating a firmware update file, according to another exemplary embodiment of the present invention;

FIG. 3 is a block diagram illustrating a data structure of a firmware update file according to an exemplary embodiment of the present invention;

FIG. 4 is a flowchart illustrating a method of updating using a firmware update file, according to an exemplary embodiment of the present invention;

FIG. 5 is a flowchart illustrating a method of updating using a firmware update file, according to another exemplary embodiment of the present invention;

FIG. 6 is a block diagram of an apparatus for generating a firmware update file according to an exemplary embodiment of the present invention; and

FIG. 7 is a block diagram of an apparatus for updating using a firmware update file according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

FIG. 1 is a flowchart illustrating a method of generating a firmware update file, according to an exemplary embodiment of the present invention. Referring to FIG. 1, the method includes generating a data body having a program code of firmware that is to be updated (operation 110); generating a data header that includes hardware model code to which the data body is to be applied, where the hardware model code includes first model code that represents a group of hardware whose firmware program codes are compatible with each other, and second model code that identifies the hardware belonging to the group (operation 120), and creating a firmware update file by combining the data body and the data header (operation 130).

Specifically, in operation 110, a data body having a firmware program that controls and manages hardware is generated. The data body is the body of a firmware update file or a ROM update file (RUF), in which essential program code of firmware is recorded.

In operation 120, a data header is generated to be added to the data body. The data header includes the model name (model code) of hardware to which the firmware is to be applied. The hardware model code includes two types of model code: first model code that represents a base hardware group maintaining firmware program code compatibility, and second model code that identifies each hardware belonging to the hardware group. Here, the first model code is a master model name, and the second model code may be model names each indicating each general hardware. For example, if model code (first model code) representing a hardware group is ‘BD-P1000’, lower model code (second model code) may be ‘BD-P1000A/XE’ and ‘BD-P1000B/XT’.

Thus, each firmware update file has a data structure designed only for a particular hardware group or each hardware model, based on hardware model codes included in the data header.

In operation 130, a firmware update file is generated by combining the data body and the data header.

Alternatively, the data header may further include a model flag field indicating whether the first model code and the second model code are valid, update mode information indicating whether firmware updating is compulsorily performed, region code indicating regions where use of the hardware is permitted, and version information. The data header may further include a digital signature in order to prevent the update file from being forged or altered. Also, the firmware program code included in the data body may be encrypted and stored in the data header, which will now be described in greater detail.

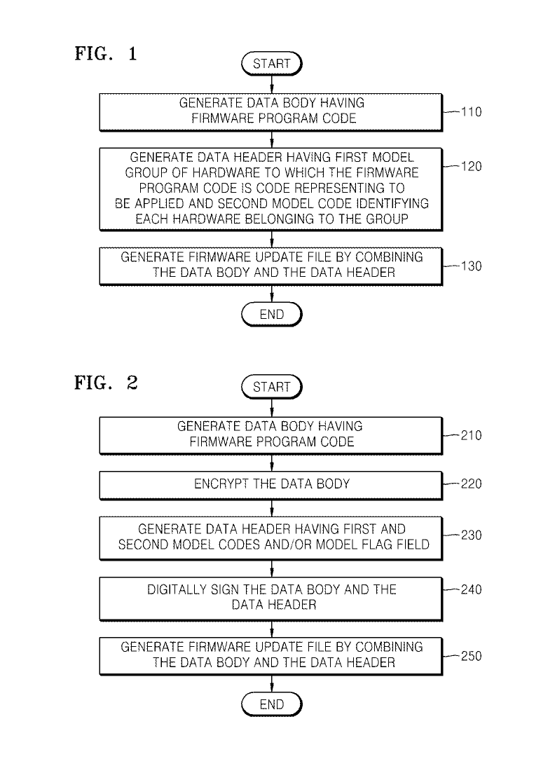

FIG. 2 is a flowchart illustrating a method of generating a firmware update file, according to an exemplary embodiment of the present invention. Referring to FIG. 2, in operation 210, a data body having firmware program code that can be updated is generated as described above with reference to FIG. 1.

In operation 220, the data body may be encrypted and stored in order to increase the security therefor. In this case, actually, the firmware program code included in the data body is encrypted, rather than the data body. That is, the firmware program code is encrypted in order to prevent a firmware program from being altered, thereby guaranteeing that the firmware program will operate normally as originally intended after firmware is installed in hardware. Further, the information (first model code, second model code, and model flag field) that is included in the original data header being not encrypted, may be inserted into the encrypted data body so that whether the information has been forged or altered can be verified. Then, during an updating process, it is possible to decrypt the encrypted data body, and compare the information inserted into the decoded data body with the information included in the data header in order to verify the integrity of model code included in the data header.

In operation 230, a data header is generated. The data header includes two types of model codes: first model code that represents a group of hardware whose firmware program codes are compatible with each other; and second model code that identifies each hardware belonging to the hardware group. The data header may further include a model flag field indicating whether the first model code and the second model code are valid. Alternatively, the model flag field may be omitted, and instead, the existing specific field value may be used in a predetermined manner. As will later be described, if region code has a free code value, the model flag field may be set to “1”, and in this case, the same operation when the first model code is valid is performed.

The data header may further include update mode information indicating that the firmware must be updated irrespective of the value of the model flag field or the values of the first and second model codes. Alternatively, the update mode information may be omitted, and instead, the existing specific field value may be used. For example, it is possible to predetermine that the firmware must be updated if the first model code has a null value.

Also, the data header may include region code and version information. The region code indicates a region (a country) where the hardware is available. For example, if a product is exported to the U.S.A., the region code indicating the U.S.A. is determined and recorded. Otherwise, in order to classify regions broadly, the region code may be recorded in units of continents or recorded as free code unconditionally. These region codes may be recorded separately, or recorded together, i.e., as a combination of the regions codes.

The version information represents the version of the firmware program code included in the data body of the firmware update file. The version information may vary according to the date when the firmware program was made and a change in the program.

In operation 240, the data body and the data header are digitally signed in order to prevent them from being forged or altered. Operation 240 is an encryption process performed on the firmware update file, which allows user authentication, a message integrity test, and a non-repudiation test.

For digital signing, a public key-based encryption algorithm and the Hash function may be used. The public key-based encryption algorithm is an asymmetric cryptographic system that uses an encryption key and a description key that are different from each other. According to this algorithm, a sender encrypts data using his/her secret key and a public key of a receiver, and transmits the encrypted data. Then, the receiver decrypts the encrypted data using his/her secret key and a public key of the sender. Such an asymmetric cryptographic system is mainly used to distribute an encryption key or a session key or perform digital signing, rather than to encrypt the content of a message. The Hash function allows a specific message to be transformed into a message digest of a predetermined length. The Hash function is a unidirectional function (non-reversibility) that does not allow the original message to be derived from a message digest, and the probability that different original messages have the same message digest is zero. Therefore, the Hash function is used to determine whether a message has been altered. Representative examples of the Hash function are the Message Digest 5 (MD5) and the Secure Hash Algorithm (SHA).

In operation 250, a firm update file is generated by combining the data body and the data header and adding a digital signature to a combination of the data body and the data header.

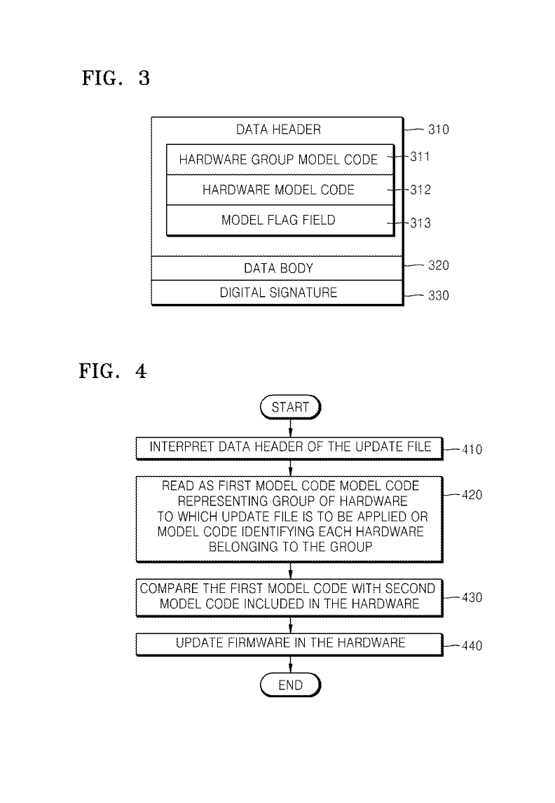

FIG. 3 is a block diagram of a data structure of a firmware update file according to an exemplary embodiment of the present invention.

As described above, the firmware update file consists of a data header 310, a data body 320 and a digital signature 330. Also, the data header 310 includes model code 311 representing a group of hardware whose firmware program codes are compatible with each other, model code 312 identifying each hardware belonging to the group, and a model flag field 313 indicating whether the model codes 311 and 312 are valid.

FIG. 4 is a flowchart illustrating a method of updating using a firmware update file, according to an exemplary embodiment of the present invention. Referring to FIG. 4, the method includes interpreting a data header of the update file (operation 410), reading as first model code model code representing a group of hardware to which the update file is to be applied or model code identifying each hardware belonging to the group, from the interpreted data header (operation 420), comparing the read first model code with second model code included in the hardware (operation 430), and updating the firmware in the hardware based on the comparison result (operation 440).

In operation 410, first, the header of the firmware update file is interpreted since the header contains various information regarding the hardware to firmware is to be applied, as described above with reference to FIG. 1 or 2.

In operation 420, model code that represents a group of hardware to which the update file is to be applied or model code that identifies each hardware belonging to the group, is read as first model code from the interpreted header of the firmware update file. That is, one of the above master model code and general model code (which are included in the data header) is selected and read so as to compare it with the model code in the hardware to which the firmware update file is to be applied.

In operation 430, the first model code is compared with the model code (second code) included in the hardware.

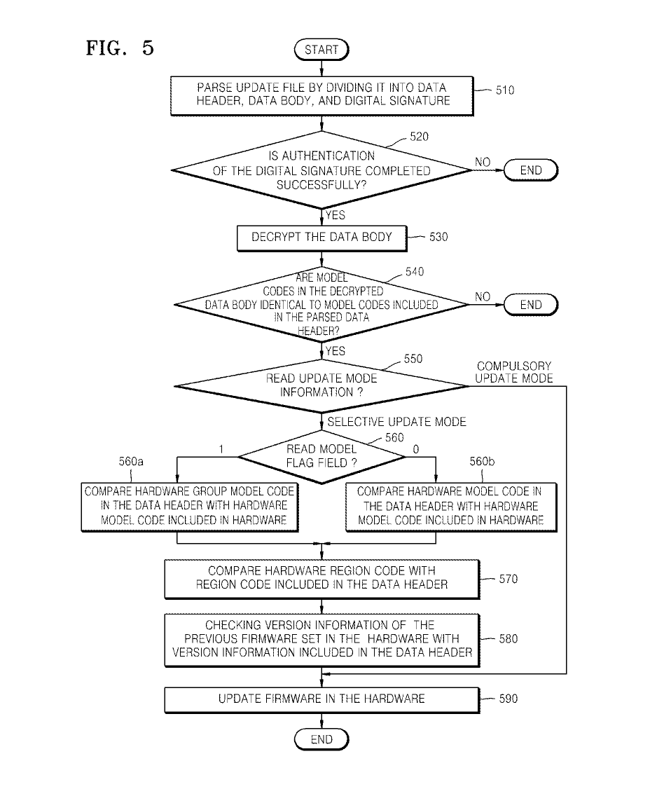

In operation 440, it is determined whether to update the firmware in the hardware, based on the comparison result. That is, if the compatibility condition for model code is satisfied, for example, if both the model codes belong to the same hardware group or are the same hardware model code, then further operations are performed so as to update the firmware (which will now be described in greater detail with reference to FIG. 5).

FIG. 5 is a flowchart illustrating a method of updating using a firmware update file, according to another exemplary embodiment of the present invention. Referring to FIG. 5, first, the firmware update file is divided into three parts: a data header, a data body, and a digital signature, and they are parsed individually (operation 510).

Next, the parsed digital signature is authenticated. For example, if the digital signature is made using the public key-based cryptographic algorithm, a decryption process is performed using a public key of a manufacturer of the firmware update file, since this algorithm is an asymmetric cryptographic system that uses an encryption key and a decryption key that are different from each other. Although those who know the public key of the manufacturer can see the firmware update file, nobody can deny that the manufacturer made the update file (non-repudiation). Therefore, the integrity of message can be verified using the firmware update file (operation 520).

When the authentication of the digital signature succeeds, the parsed data body is decrypted if the parsed data body is encrypted (operation 530). Next, model code that represents a group of hardware to which the update file is to be applied, and model code that identifies each hardware belonging to the group are read from the decrypted data body, and it is determined whether the read model codes are identical to model code included in the parsed data header (operation 540). That is, the integrity of the model code included in the parsed data header is verified.

Next, update mode information is read from the data header in order to determine whether updating of the firmware is compulsorily performed (operation 550). If the update mode information is set as a compulsory update mode, the firmware in the hardware must be updated unconditionally (operation 590).

If the model code that is included in the data header and represents the group of hardware to which the update file is to be applied has been predetermined to have a null value, it is possible to determine that the update mode information is set as the compulsory update mode.

If it is determined in operation 550 that the update mode information does not indicate the compulsory update mode, that is, if it indicates a selective update mode, then a model flag field is read (operation 560).

The model flag field may have a one-bit value of “1” or “0”, where 1's and 0's may be used interchangeably. For example, if the model flag field is set to “1”, master model names are compared with each other, that is, the model code that is included in the data header and represents the hardware group is compared with hardware model code that is included in hardware to which the firmware update file is to be actually applied (operation 560a). Thus, as described above, if a master model name in the data header is “BD-P1000” and the model name of hardware that is to be updated is “BP-P1000A/XE”, then the hard model, “BP-P1000A/XE” is included the hardware group, “BD-P1000”, and therefore, the firmware in the hardware can be updated.

Operation 560a is performed when the master model name is used, that is, when the model code representing the hardware group is activated depending on the value of the model flag field. However, a general hardware model name may be directly used.

If a hardware model name is directly used, it means that the model flag field is set to “0” (operation 560b). For example, if the data header of the firmware update file includes the hardware group model code entitled “BD-P1000” and the hardware model code entitled “BD-P1000B/XT”, and the model flag field is set to “0”, then the hardware model codes must be compared in order to determine whether firmware updating is necessary. Thus, in this case, hardware firmware entitled “BP-P1000A/XE” cannot be updated using the firmware update file. That is, if the hardware model codes are not the same, updating is not further performed and the method ends directly. This is because the firmware update file is manufactured such that updating of the firmware is limited according to the type of hardware model.

Alternatively, in operation 560, the existing specific field value may be used in a predetermined manner without the model flag field. For example, if region code is used and is free code, operation 560a may be performed similarly to when the model flag field is set to “1”. Adversely, if the region code is set to a specific value, operation 560b may be performed similarly to when the model flag field is set to “0”.

Alternatively, the method of FIG. 5 may further include comparing region code included in the hardware with region code included in the firmware update file (operation 570). If the region codes are free codes, operation 570 is skipped unconditionally. If the region code in the hardware is a continent code and the region code in the firmware update file is a country code, it is determined whether the country code is included in the continent code. If the region codes are country codes, it is determined whether they are identical to each other.

The method of FIG. 5 may further include checking the firmware version information preset in the hardware in order to determine whether to update the firmware update file (operation 580). That is, firmware updating can be performed only if the version of the firmware update file is later than that of the previous firmware. Therefore, the version of the firmware in the hardware is checked and then firmware is updated depending on the checking result (operation 590).

However, a point of time when performing operation 520 in which the digital signature is authenticated is not limited if it can be performed before firmware updating. A point of time when performing operation 550 in which the update mode information is interpreted is also not limited if it can be performed before operation 560 in which the model flag field is interpreted.

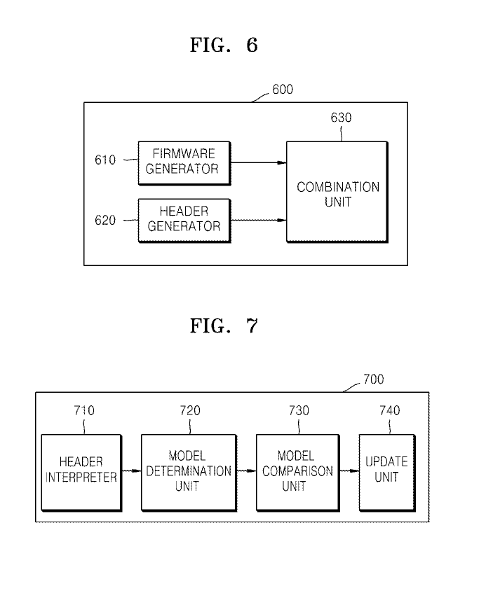

FIG. 6 is a block diagram of an apparatus 600 for generating a firmware update file, according to an exemplary embodiment of the present invention.

The apparatus 600 includes a firmware generator 610, a header generator 620, and a combination unit 630.

The firmware generator 610 generates a data body that includes firmware program code that can be updated, and transmits the data body to the combination unit 630.

The header generator 620 generates a data header that includes model code of hardware to which the data body is to be applied. The hardware model code includes first model code that represents a group of hardware whose firmware program codes are compatible with each other, and second model code that identifies each hardware belonging to the group.

The combination unit 630 receives the data body and the data header, and generates a firmware update file (RUF) by combining them. Although not shown, the combination unit 630 may further include a digital signature unit that selectively digitally signs the data body and the data header in order to prevent them from being forged or altered, and an encryption unit that encrypts the data body having the firmware program code.

FIG. 7 is a block diagram of an apparatus 700 for generating a firmware update file, according to another exemplary embodiment of the present invention. The apparatus 700 includes a header interpreter 710, a model determination unit 720, a model comparison unit 730, and an update unit 740.

The header interpreter 710 interprets a data header included in the update file. The model determination unit 720 reads as first model code model code that represents a group of hardware to which the update file is to be applied or model code that identifies each hardware belonging to the group, from the interpreted data header.

The model comparison unit 730 compares the first model code with second model code that is included in the hardware and represents a hardware model.

The update unit 740 updates firmware in the hardware, based on the comparison result received from the model comparison unit 730.

Alternatively, the apparatus 700 may further include a syntax parser (not shown) that the divides the update file into the data header, a data body, and a digital signature and parses them individually, the data header having model code representing a group of hardware and model code representing each hardware belonging to the group, the data body having firmware program code that can be updated, and the digital signature that prevents the firmware update firm being forged or altered. Although not shown, the syntax parser may include a digital signature authentication unit that authenticates the parsed digital signature; a decryption unit that decrypts the data body if the digital signature authentication unit completes the authentication successfully and if the parsed data body is encrypted; and an update mode determination unit that interprets update mode information from the data header interpreted by the header interpreter 710 so as to determine whether updating of the firmware is compulsorily performed.

The method of generating a firmware update file and the method of updating firmware using the firmware update file, according to the present invention, can be embodied as a computer program. The computer program may be stored in a computer readable medium, and executed using a general digital computer.

Also, the data structure of a firmware update file according to the present invention can be recorded on a computer readable medium via various devices.

The computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on.

As described above, a method and apparatus for generating a firmware update file and a method and apparatus for updating firmware using the firmware update file according to the exemplary embodiments make it is possible to prevent the firmware from being indiscriminately updated in an inappropriate hardware model by limiting updating of the firmware according to the type of hardware model using the firmware update file. Further, since firmware can be updated according to the type of master model, it is possible to more flexibly group the ranges of hardware that can be updated.

Thus, since indiscriminative firmware updating can be prevented by limiting updating, it is possible to prevent legal troubles between a hardware manufacturing company and a copyright holder of a firmware program.

Further, it is possible to increase the security for a firmware program by encrypting the firmware program, and verify the integrity for firmware using a digital signature during updating of the firmware.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of generating an update file of firmware, the method comprising:
generating a data body comprising firmware program code that is to be updated;
generating a data header comprising model code of hardware to which the data body is to be applied, wherein the hardware model code comprises first model code representing a group of hardware having firmware program codes which are compatible with each other and second model code identifying each hardware belonging to the group; and
generating a firmware update file by combining the data body and the data header.

2. The method of claim 1, wherein the data header further comprises a model flag field indicating whether the first and second model codes are valid.

3. The method of claim 2, wherein the data header further comprises update mode information indicating whether updating of the firmware is compulsorily performed irrespective of a value of the model flag field.

4. The method of claim 2, wherein, if updating of the firmware is compulsorily performed, the generating the data header comprises setting the first model code included in the data header to a null value.

5. The method of claim 1, wherein the data body further comprises the first and second model codes.

6. The method of claim 5, wherein the data header further comprises region code of the hardware to which the data body is to be applied.

7. The method of claim 6, wherein the region code of the hardware comprises at least one of free code, continent code, and country code.

8. The method of claim 7, wherein the data header further comprises version information of the firmware program code.

9. The method of claim 1, wherein the generating the firmware update file comprises digitally signing the data body and the data header so as to prevent the data body and the data header from being forged or altered.

10. The method of claim 1, wherein the generating the firmware update file comprises encrypting the data body.

11. A method of updating firmware using a firmware update file, the method comprising:
interpreting a data header included in an update file;
reading as first model code one of model code representing a group of hardware to which the update file is to be applied and model code identifying each hardware belonging to the group, from the data header;
comparing the first model code with second model code included in the hardware, wherein the second model code represents models of the hardware; and
updating firmware in the hardware based on a result of the comparing.

12. The method of claim 11, wherein the reading the first model code comprises:
interpreting a model flag field indicating whether the model code representing the hardware group and the model code identifying each hardware belonging to the group are valid; and
determining one of the model code representing the group and the model code identifying each hardware belonging to the group as the first model code, based on a value of the model flag field.

13. The method of claim 12, wherein, if the model code representing the hardware group is read as the first model code according to the value of the model flag field, the updating the firmware in the hardware comprises updating the firmware in the hardware only if the second model code is included in the first model code.

14. The method of claim 12, wherein, if the model code identifying each hardware belonging to the group are valid is read as the first model code according to the value of the model flag field, the updating the firmware in the hardware comprises updating the firmware in the hardware only if the second model code is identical to the first model code.

15. The method of claim 14, further comprising:
reading region code of the hardware to which the update file is to be applied, from the data header which is interpreted; and
comparing the read region code with region code of the hardware that is included in the hardware so as to determine whether the firmware is to be updated.

16. The method of claim 15, further comprising comparing firmware version information preset in the hardware with version information included in the interpreted data header so as to determine whether the firmware is to be updated.

17. The method of claim 12, further comprising:
interpreting update mode information indicating whether the firmware is compulsorily updated, wherein the update mode information is included in the data header; and
if a result of the interpreting the update mode information indicates a compulsory update mode, updating the firmware in the hardware, irrespective of a result of the comparing the first and second model codes.

18. The method of claim 17, wherein, if the model code that is included in the data header and represents the group of the hardware to which the update file is to be applied, has a null value, the interpreting the update mode information comprises interpreting the update mode information to indicate the compulsory update mode.

19. The method of claim 11, further comprising parsing the update file by dividing the update file into the data header that includes the model code representing the group of the hardware to which the update file is to be applied and the model code identifying each hardware belonging to the group, a data body having firmware program code that is to be updated, and a digital signature that prevents the update file from being forged or altered.

20. The method of claim 19, further comprising authenticating the parsed digital signature,
wherein, if the authentication succeeds, the firmware in the hardware is updated.

21. The method of claim 20, if the parsed data body is encrypted, further comprising:
decrypting the data body;
interpreting model code representing the group of hardware to which the update file is to be applied and model code identifying each hardware belonging to the group, wherein the model codes are included in the decrypted data body; and
comparing the interpreted model codes with the model codes included in the parsed data header in order to verify the integrity of the model codes included in the parsed data header.

22. An apparatus for generating a firmware update file, the apparatus comprising:
a firmware generator which generates a data body comprising firmware program code that is to be updated;
a header generator which generates a data header comprising model code of hardware to which the data body is to be applied, wherein the model code comprises first model code representing a group of hardware having firmware program codes which are compatible with each other and second model code that identifies each hardware belonging to the group; and
a combination unit which generates a firmware update file by combining the data header and the data body.

23. The apparatus of claim 22, wherein the combination unit comprises:
a digital signature unit which digitally signs the data body and the data header so as to prevent the data body and the data header from being forged or altered; and
an encryption unit which encrypts the data body having the firmware program code.

24. An apparatus for updating using a firmware update file, the apparatus comprising:
a header interpreter which interprets a data header included in an update file;
a model determination unit which reads as first model code model code that represents a group of hardware to which the update file is to be applied or model code that identifies each hardware belonging to the group, from the interpreted data header;
a model comparison unit which compares the first model code with second model code that is included in the hardware and indicates models of the hardware; and
an update unit which updates firmware in the hardware, based on a comparison result received from the model comparison unit.

25. The apparatus of claim 24, further comprising:
a syntax parser which parses the update file by dividing the update file into the data header having the model code that represents a group of hardware to which the update file is to be applied and the model code that identifies each hardware belonging to the group, a data body having firmware program code that is to be updated, and a digital signature that prevents the update file from being forged or altered;
a digital signature authentication unit which authenticates the digital signature parsed by the syntax parser;
a decryption unit which decrypts the parsed data body if the digital signature authentication unit completes the authentication successfully and if the parsed data body is encrypted; and
an update mode determination unit which interprets update mode information included in the data header interpreted by the header interpreter, wherein the update mode information indicates whether updating of the firmware is to be performed compulsorily.
